(19) United States
(12) Patent Application Publication
(10) Pub. No.: US 2017/0174310 A1
(43) Pub. Date: Jun. 22, 2017

(54) COVER FOR A WINDOW IN AN AIRCRAFT

(71) Applicant: Airbus Operations GmbH, Hamburg (DE)

(72) Inventor: Marcus KLETTKE, Hamburg (DE)

(21) Appl. No.: 15/384,656

(22) Filed: Dec. 20, 2016

(30) Foreign Application Priority Data
Dec. 21, 2015 (DE) 202015106959.6

(51) Int. Cl. B64C 1/14

(52) U.S. Cl. CPC B64C 1/1484

(57) ABSTRACT

The present disclosure relates to a cover for a window in an aircraft, the window having an outer window panel on the side that is directed towards the interior of the aircraft. Holding means or structure for holding a card at the outer window panel are provided at the outer window panel. The holding means or structure is configured to hold the card in front of the interior side of the window with a positive fit.

### CROSS-REFERENCE TO RELATED APPLICATION(S)

This application claims priority to German patent application number 202015106959.6, filed Dec. 21, 2015, which is incorporated herein by reference in its entirety.

### TECHNICAL FIELD

The present disclosure relates to a cover for a window in an aircraft. Presently, the term aircraft particularly comprises passenger planes.

### BACKGROUND

Conventional ways of shading a cabin of a passenger plane use window blinds, which may be moved manually to an aspired position, for example. Furthermore, windows are known, which are electrically dimmable via a cabin management system. It is the object of this shading to protect passengers from blinding sun or prepare them for the time zone of the airport at the destination.

The drawback of these known solutions is that the time-consuming maintenance of the electrically dimmable windows is not always possible during regular maintenance and cleaning intervals. Further, for some passengers, the shading via the dimmable windows is not dark enough.

At the same time, airlines are interested in using light effects, e.g. northern lights, in the cabin as a feature of market differentiation. In this regards, further lights might be possible, which increase the plane's weight. Furthermore, in an airplane, where energy is limited, it is always aspired to save energy.

### BRIEF SUMMARY

It is therefore an object of the present invention to provide an energy efficient shading mechanism, which, if needed, may be exchanged quickly, while not increasing weight.

This object is solved by the device described and claimed herein. Embodiments of the invention are encompassed by the claims.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a schematic front view of a window of an aircraft, which is configured according to an embodiment of the present invention.

FIG. 2 illustrates a side view of an outer window panel according to an embodiment of the present invention.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

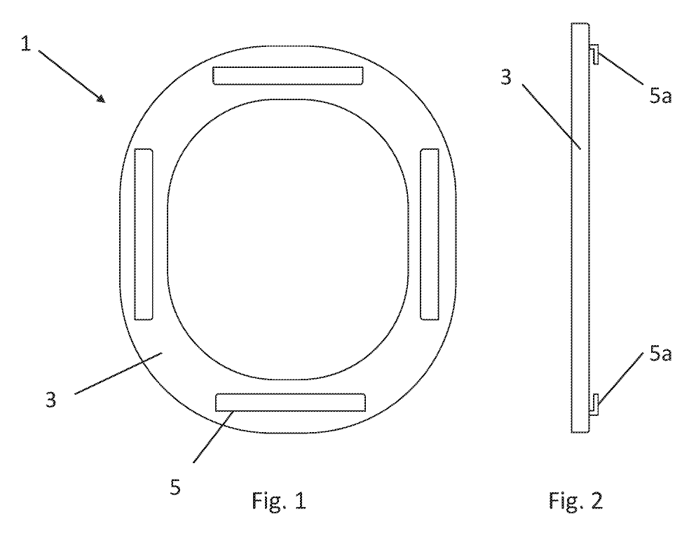

FIG. 1 illustrates is a schematic front view of a window 1 of an aircraft according to the present invention. The window comprises an outer window panel 3 on that side, which is directed towards the interior of the aircraft. Holding means 5 for holding a card (not illustrated) with a positive fit (from-fit) are provided at this outer window panel.

FIG. 2 illustrates holding means 5 in the form of L-shaped guiding rail 5a, which are mounted to the outer window panel 3. This form is particularly suitable for insertion and holding of a card such that a shading or a special design of the aircraft cabin is possible.

### REFERENCE NUMBERS

1—Window
3—Outer window panel
5—Holding means
5a—L-shaped guiding rail

The inventive cover for a window in an aircraft is configured such that the window comprises at the side, which is directed towards the interior of the aircraft, an outer window panel, wherein holding means for holding a card at the outer window panel are provided at the outer window panel. The holding means are configured to hold the card with a positive fit (form-fit) in front of that side of the window, which is directed towards the interior of the aircraft.

In the scope of the present disclosure, the term “positive fit” means that the card at least partially rests against the airplane wall such that no sun light enters the interior of the airplane through the window without having to pass the card.

In other words, the window, through which a passenger of the airplane may look outside, may be, optionally completely, covered by the card. Optionally, the card is configured such that it may cover the window of a passenger airplane preferably completely. Such a complete covering of the window with the card allows a shading of the airplane interior, for example. In other words, light incidence through the window from the outside can be prevented by the card.

The card may have a rectangular shape, wherein other shapes also conceivable in this regard. Optionally, the card constitutes an element, which is significantly longer and wider than high. Optionally, the card is elastically deformable. In other words, the card may adopt its original shape after application of a force and deformation, once said force is not applied thereto anymore.

According to embodiments of the invention, the card may be positioned before or behind the outer window panel, when viewed from the interior of the aircraft.

According to an embodiment, three or more guiding rails are provided as holding means. The holding means may be structured integrally and integrally with the outer window panel, respectively, for example. The guiding rails may be structured such that the card may be inserted therein. Two guiding rails may be positioned in parallel to each other, for example, wherein, optionally, said guiding rails exhibit a distance therebetween, which allows an insertion of the card such that both rails hold the card. A third guiding rail may be positioned between said parallel guiding rails for providing a stop for the card. Accordingly, this embodiment allows the card to be held in position by the three guiding rails, wherein a removal of the card towards the top is possible.

In a further embodiment, the card comprises four guiding rails, wherein one of the guiding rails is detachably mounted such that an exchange of the card is easily conductible. The fourth guiding rail may be provided at the upper end of the window such that the card, after loosening said one guiding rail, may be extracted from the remaining guiding rails towards the top.

The guiding rails may be structured with a L-shape such that an insertion of the card is easily conducted via sliding. Optionally, the guiding rails exhibits an L-shaped sectional shape.

According to an embodiment, the cover for a window in an aircraft may comprise a U-shaped holding means. This is possible for the embodiment having the card positioned behind and the embodiment having the card positioned in front of the outer window panel, when viewed from the interior of the aircraft. With this embodiment, only little card material is necessary, leading to weight saving, and, further, there are no protruding edges such that there is a good overall aesthetic appearance. Optionally, the holding means of this embodiment comprise a U-shaped sectional shape. The holding means may be connected to the window panel with that section of the U, which connects the two parallel sections of the U.

According to an embodiment, the holding means comprise velcro fasteners or magnets. These holding means may be utilized in combination with the guiding rails, for example. It is also conceivable that the holding means comprise velcro fasteners and/or magnets such that the card is attachable to the window panel by merely moving it from the airplane interior in the direction of the window by providing velcro fasteners and/or magnets having elements on the card and on the window panel, which are coupled, e.g. engaged, by such a movement.

Optionally, the card is luminescent, transparent, trans-luminescent or opaque. It is also conceivable that the card exhibits several of these characteristics at the same time. This allows satisfying different needs of passengers and airlines. A transparent or an at least partially transparent card may be utilized for guiding the passenger's attention to the card, for example.

This is desirable if the card comprises safety instructions, for example. It is also conceivable that the card comprises commercials or creative elements, for which the background light of the sun may be utilized in an energy efficient way. At the same time, it is possible to provide a completely opaque card to allow good shading for light sensitive passengers. In the present invention, the term “transparent” means see-through or clear (like glass). The term “translucent” means gleaming but not translucent. The term “luminescence” means gleaming glow.

The cover may comprise a card, wherein the cover and the card are, optionally, configured such that the card covers the complete window upon accommodation in the holding means.

The card may comprise a lug for removing it from the holding means. The lug may be manufactured from moisture repellent material, e.g., plastic. This prevents the lug from absorbing any liquids, as spilled drinks, spittle from, e.g., babies etc., and ensures an easy cleaning.

The card may be dimensionally stable. According to the present invention, the term dimensionally stable implies that the card does not collapse under its own weight. If the card is held at its lower end and extends upwards from the holding point, for example, the card maintains its form and does not collapse, as a piece of paper, for example. The card may be an at least partially laminated sheet, for example. The card may comprise laminated edges, which may be made of plastic. Also, the card may be a completely laminated sheet, optionally a laminated piece of paper.

According to an embodiment, the cover is configured such that the card may be removed from and inserted into the holding means by a passenger during the intended use of the cover. According to the present invention, the intended use of the cover is the use for its designed purpose, i.e. for covering a window of an aircraft. Optionally, the cover according to this embodiment may be removed from and inserted into the holding means without any additional tooling.

According to an embodiment, the cover may comprise at least one clamping element for clamping the card in the holding means. This secures the card in position. Multiple clamping elements may also be provided. The clamping element/clamping elements may be configured to hold the card under tension. The clamping element may comprise a protrusion, which is, optionally, provided at the outer window panel. The protrusion allows the card to be clamped between the outer window panel and the holding means.

Furthermore, the present disclosure relates to an aircraft window having a cover according to one of the preceding embodiments.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A cover for a window in an aircraft, the window comprising an outer window panel on a side directed towards an interior of the aircraft, the cover comprising:
holding means for holding a card at the outer window panel, provided at the outer window panel; and
wherein the holding means are configured to hold the card with a positive fit in front of the side of the window, which is directed towards the interior of the aircraft.

2. The cover for a window in an aircraft according to claim 1, wherein the card, when viewed from the interior of the aircraft, is positioned in front of or behind the outer window panel.

3. The cover for a window in an aircraft according to claim 1, wherein the holding means comprises three or more guiding rails.

4. The cover for a window in an aircraft according to claim 3, comprising four guiding rails, wherein one of the four guiding rails is detachably mounted.

5. The cover for a window in an aircraft according to claim 1, wherein the guiding rails are L-shaped.

6. The cover for a window in an aircraft according to claim 1, wherein the holding means are formed U-shaped.

7. The cover for a window in an aircraft according to claim 1, wherein the holding means comprise velcro fasteners.

8. The cover for a window in an aircraft according to claim 1, wherein the holding means comprise magnets.

9. The cover for a window in an aircraft according to claim 1, wherein the card is formed to be luminescent, transparent, transluminescent or opaque.

10. The cover according to claim 1, wherein the card comprises safety instructions, advertising or creative elements.

11. The cover according to claim 1, further comprising a card, wherein the cover and the card are configured such that the card, upon accommodation in the holding means, covers the complete window.

12. The cover according to claim 11, wherein the card is dimensionally stable, and wherein the card comprises an at least partially laminated sheet.

13. The cover according to claim 1, wherein the card is removable from and insertable into the holding means during use of the cover.

14. The cover according to claim 1, further comprising at least one clamping element for clamping the card.

15. The cover according to claim 14, wherein the clamping element comprises a protrusion, the protrusion, optionally, being provided at the outer window panel.

16. An aircraft window comprising a cover, the window comprising an outer window panel on a side directed towards an interior of the aircraft, wherein holding means for holding a card at the outer window panel are provided at the outer window panel, and wherein the holding means are configured to hold the card with a positive fit in front of the side of the window directed towards the interior of the aircraft.
